(19) United States
(12) Patent Application Publication
(10) Pub. No.: US 2008/0081852 A1
(43) Pub. Date: Apr. 3, 2008

(54) MOUTH GUARD COMPOSITION

(75) Inventors: Hiroshi KAMOHARA, Itabashi-ku (JP); Shouichi Fukushima, Itabashi-ku (JP); Miyuki Tsunooka, Itabashi-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: GC Corporation, Itabashi-ku (JP)

(21) Appl. No.: 11/859,341

(22) Filed: Sep. 21, 2007

(30) Foreign Application Priority Data
Sep. 29, 2006 (JP) 2006-269399

(51) Int. Cl. C08L 25/08

(52) U.S. Cl. 523/121

(57) ABSTRACT

A mouth guard composition comprises 39 to 98% by weight of styrene block copolymer; 1 to 60% by weight of one or more kinds of thermoplastic resins selected from the group consisting of aliphatic cyclic saturated hydrocarbon resin, terpene resin, aliphatic petroleum resin and ester gum; and 0.1 to 40% by weight of one or more kinds of waxes selected from the group consisting of mineral wax, synthetic wax, plant wax, and animal wax, said composition further comprising 0.1 to 20% by weight of polyolefin resin, thereby providing the mouth guard composition which is not largely distorted when extremely strong impact force is applied thereto during the use of the mouth guard and can protect teeth and jaws, and little wearing is caused when repetitive force is applied.

### BACKGROUND OF THE INVENTION

1. Field of the Invention

The present invention relates to a mouth guard composition for the preparation of a mouth guard that prevents an external injury of teeth and the peripheral tissue thereof caused in sport.

2. Description of the Conventional Art

In a contact sport such as Karate, boxing, American football, or soccer, there often occurs such case that big impact force is applied to teeth or jaws during the sport. Therefore, a mouth guard made from an elastic material is placed in an oral cavity to absorb the impact force for protecting jaws and oral system and minimizing an external injury that may be caused during the sport.

There are a wide variety of materials employed for such a mouth guard, and ethylene-vinyl acetate copolymer or polyolefin rubber is now mostly used for the material. Although these materials are advantageous to the most of players of such a sport because of relatively low cost, there have been several problems that the mouth guard may be torn when big impact force is applied during the sport, odors may be adhered to the mouth guard due to the use, or it is deteriorated by the abrasion thereof. Further, with respect to the hardness of this mouth guard, difference in required characteristics is large depending on the kind of the contact sport and the players thereof. Particularly, for high level players of professional sports, the general mouth guard does not have sufficient resistance against the impact force so that it is easily deformed, and further the mouth guard maybe remarkably worn by stronger biting force than that of general players.

For the material that is improved in view of these problems, a mouth guard composition comprising styrene block copolymer, aliphatic cyclic saturated hydrocarbon resin and/or ester gum, organopolysiloxane in which at least one of organic groups directly bonded to the silicon atom in one molecular thereof is phenyl group, methyl styryl group or an alkyl group having 7 to 30 carbon atoms, whereby the tear strength can be enhanced (for example, see JP-A-2001-54610); or a mouth guard composition comprising styrene block copolymer with thermoplastic resin such as aliphatic cyclic saturated hydrocarbon resin added thereto and wax, whereby the obtained mouth guard exhibits a high tear strength, plastic deformation is hardly caused by biting force, and no odor is generated by the use thereof (for example, see JP-A-2003-019240) have been disclosed. However, though these mouth guard of the prior art have been improved such that plastic deformation or tear thereof is hardly caused by biting force, resistance against impact force has not been considered. In particular, when the conventional mouth guard is subjected to extremely large impact force or biting force, for example, in professional sports, the distortion thereof is contiguously increased by repeatedly received strong impact force prior to recovery of the plasticity, resulting in that teeth may be broken or jaws may be considerably damaged. Moreover, the conventional mouth guard has a problem of being worn due to the repeatedly received force, causing the deterioration of the durability thereof.

### SUMMARY OF THE INVENTION

The object of the present invention is to provide a mouth guard composition which is not largely distorted when subjected to extremely strong impact force during the use of the mouth guard, thereby protecting teeth and jaws, and also is not worn even if the force is repeatedly applied thereto.

The present inventors have dedicatedly studied to solve the above problems and found that, when a composition for a mouth guard comprising a styrene block copolymer; one or more kinds of thermoplastic resins selected from the group consisting of aliphatic cyclic saturated hydrocarbon resin, terpene resin, aliphatic petroleum resin, and ester gum; and one or more kinds of waxes selected from the group consisting of mineral wax, synthetic wax, plant wax, and animal wax, further comprises a polyolefin resin, the hardness of a mouth guard is enhanced, distortion at the time of large impact force being applied is made small, and wearing at the time of repeated force being given is substantially reduced, and the present invention has been thus achieved.

That is, the present invention is the mouth guard composition comprising: 39 to 98% by weight of styrene block copolymer; 1 to 60% by weight of one or more kinds of thermoplastic resins selected from the group consisting of aliphatic cyclic saturated hydrocarbon resin, terpene resin, aliphatic petroleum resin, and ester gum; and 0.1 to 40% by weight of one or more kind of waxes selected from the group consisting of mineral wax, synthetic wax, plant wax, and animal wax, wherein said composition further comprises 0.1 to 20% by weight of polyolefin resin.

The mouth guard composition according to the present invention is an excellent mouth guard composition which is not largely distorted even when extremely strong impact force is repeatedly applied thereto during use, thereby protecting teeth and jaws, and it is not much worn.

### DETAILED DESCRIPTION OF THE PREFERRED EMBODIMENTS

The composition that is fundamental of the mouth guard composition according to the present invention comprises 39 to 98% by weight of styrene block copolymer; 1 to 60% by weight of one or more kinds of thermoplastic resins selected from the group consisting of aliphatic cyclic saturated hydrocarbon resin, terpene resin, aliphatic petroleum resin, and ester gum; and 0.1 to 40% by weight of one or more kinds of waxes selected from the group consisting of mineral wax, synthetic wax, plant wax, and animal wax.

The styrene block copolymer used in the mouth guard composition of the present invention may include, for example, a block copolymer of polystyrene and polybutadiene, a block copolymer of polystyrene and polyisoprene, and a block copolymer of polystyrene and polyolefin. Among them, the block copolymer of polystyrene and polyolefin is the most desirable in view of the hardness and the softening point temperature and the like required for the mouth guard. This styrene block copolymer is required to present in the mouth guard composition by 38 to 98% by weight. When it is less than 38% by weight, the hardness required for the mouth guard is not sufficient, while when it is over 98% by weight, the softening point temperature of the mouth guard composition is increased which will make the composition difficult to be produced or prepared.

One or more kinds of thermoplastic resins selected from the group consisting of aliphatic cyclic saturated hydrocarbon resin, terpene resin, aliphatic petroleum resin, and ester gum provide an effect to improve the flowability at the time of softening by heating and, further, provide an effect to make it difficult to cause plastic deformation when used together with one or more kinds of waxes selected from the group consisting of a mineral wax, a synthetic wax, a plant wax, and an animal wax, which will be described in more detail below.

Although a number average molecular weight of common aliphatic cyclic saturated hydrocarbon is in the range from 500 to 900, that having 550 to 650 of a number average molecular weight is preferred in order to achieve readily softening for the production of the mouth guard. For the terpene resin, there is terpene resin which is hydrogenated, other than the typical terpene resin and such the hydrogenated terpene resin may also be used. It is preferred that any terpene resin has a number average molecular weight in the range from 400 to 800. For the aliphatic petroleum resin, that having a number average molecular weight in the range from 700 to 1,200 are preferably used. These thermoplastic resins may be solely used or in the combination of two or more thereof may be used, and the content thereof is in the range from 1 to 60% by weight, more preferably in the range from 10 to 25% by weight based on the entire composition for the mouth guard. When this component is less than 1% by weight, the effect to improve the flowability at the time of softening by heating is not sufficient, while, when it is over 60% by weight, the strength of the mouth guard will be reduced to the level where the mouth guard can not withstand strong biting force. The ester gum prepared by esterifying rosin with glycerine is common and that prepared by esterifying rosin hydride with glycerine may also be used.

One or more kinds of waxes selected from the group consisting of mineral wax, synthetic wax, plant wax, and animal wax provide a property of cutting off plastic deformation at the time of strong force being applied to the mouth guard when used together with the resin components as described above. As the representative wax for each kind thereof, paraffin wax, microcrystalline wax and the like for the mineral waxes; low molecular polyethylene, Fischer-Tropsch wax and the like for the synthetic waxes; carnauba wax, candelilla wax and the like for the plant waxes; and bee wax, shellac and the like may be exemplified.

The content of the wax component is in the range from 0.1 to 40% by weight, more preferably in the range from 1 to 20% by weight based on the entire composition for the mouth guard. When it is less than 0.1% by weight, the mouth guard will easily cause plastic deformation. When it is over 40% by weight, the tear strength will be reduced and, as a result, abrasive resistance is deteriorated.

For the polyolefin resin, high density polyethylene prepared by polymerizing ethylene monomers, low density polyethylene prepared by a high pressure process, linear low density polyethylene and the like can be exemplified. For the polypropylene resin, a homopolymer prepared by homopolymerizing propylene, a copolymer of propylene with ethylene and the like can be exemplified. The content of this polyolefin resin being in the range from 0.1 to 20% by weight, in particular, 1 to 10% by weight may be preferably used. When it is less than 0.1% by weight, the hardness is low and the permanent deformation is large, while when it is over 20% by weight, the hardness is so high that it is very difficult to attach or detach the mouth guard into or from an oral cavity.

Among the polyolefin resins, polypropylene resin is particularly preferred. In general, when the polypropylene resin having a high softening point is added to a composition having elasticity like the mouth guard, the softening point temperature is increased and it could not be molded by the conventional mouth guard molding method. However, in the mouth guard composition in accordance with the present invention, the softening point temperature is not increased and moldability is not reduced. In the mouth guard produced by the mouth guard composition according to the present invention, the hardness is increased due to the content of the polyolefin resin whereby the mouth guard is not caused to be largely distorted when strong impact force is applied thereto. Further, since the polyolefin resin is homogeneously heated and dissolved together with the other components with the combination as disclosed in the present invention, the hardness is increased and the property not to be largely worn due to repetitive force or biting can be provided.

To the composition for the mouth guard according to the present invention, various kinds of inorganic or organic coloring agents, known plasticizers, known inorganic fillers, known antioxidants, or known antibacterial agents may further be used in the range where the properties are not lost.

### EXAMPLES

The present invention will now be described in more detail below with reference to the following embodiments, but the present invention is not limited thereto.

### Example 1

| | |
|---|---|
| Block copolymer of polystyerene and polyolefin | 59% by weight |
| Aliphatic cyclic saturated hydrocarbon resin | 25% by weight |
| Ester gum | 10% by weight |
| Paraffin wax (mineral wax) | 1% by weight |
| Polypropylene (homopolymer) | 5% by weight |

The above components were heated and kneaded by a pressurize kneader at a temperature of 130 to 150 degrees C., and thereby a sheet having 130 mm diameter and 3 mm thickness was molded.

### Difficulty to be Distorted: Evaluation of Dynamic Mudulus of Elasticity

In order to determine the difficulty to be distorted of this disc-shaped composition for the mouth guard, the dynamic modulus of elasticity thereof at a temperature within the oral cavity (37 degrees C.) was measured by using a dynamic viscoelasticity measurement apparatus (trade name: Rheogel-E2500, manufactured by UBM company) at frequencies of 1 Hz and 10 Hz, respectively. The results are shown in Table 1.

### Evaluation of Difficulty to be Worn

Also, in order to evaluate the degree of wearing due to repeated biting force, the above sheet that has been molded into the sheet shape was used to actually produce a mouth guard with a heating former and the degree of wearing was evaluated for the bitten surface after 20 times repeated use in an oral cavity.

### Example 2

| | |
|---|---|
| Block copolymer of polystyrene and polyolefin | 63% by weight |
| Aliphatic cyclic saturated hydrocarbon resin | 25% by weight |
| Ester gum | 10% by weight |
| Paraffin wax (mineral wax) | 1% by weight |
| Polypropylene (homoplymer) | 1% by weight |

The above components were heated and kneaded by a pressurize kneader at a temperature of 130 to 150 degrees C., and thereby a sheet having 130 mm diameter and 3 mm thickness was molded. With this composition, the same tests as in Example 1 were carried out. The results are shown in Table 1.

### Example 3

| | |
|---|---|
| Block copolymer of polystyrene and polyolefin | 44% by weight |
| Aliphatic cyclic saturated hydrocarbon resin | 25% by weight |
| Ester gum | 10% by weight |
| Paraffin wax (mineral wax) | 1% by weight |
| High density polyethylene | 20% by weight |

The above components were heated and kneaded by a pressurize kneader at a temperature of 130 to 150 degrees C., and thereby a sheet having 130 mm diameter and 3 mm thickness was molded. With this composition, the same tests as in Example 1 were carried out. The results are shown in Table 1.

### Example 4

| | |
|---|---|
| Block copolymer of polystyrene and polyolefin | 67.5% by weight |
| Ester gum | 20% by weight |
| Paraffin wax (mineral wax) | 2% by weight |
| Copolymer of propylene and ethylene | 10% by weight |
| Yellow No. 250 (coloring agent) | 0.1% by weight |
| BHT (antioxidant agent) | 0.1% by weight |
| Silver antibacterial agent | 0.3% by weight |

The above components were heated and kneaded by a pressurize kneader at a temperature of 130 to 150 degrees C., and thereby a sheet having 130 mm diameter and 3 mm thickness was molded. With this composition, the same tests as in Example 1 were carried out. The results are shown in Table 1.

### Comparative Example 1

| | |
|---|---|
| Block copolymer of polystyrene and polyolefin | 64% by weight |
| Aliphatic cyclic saturated hydrocarbon resin | 25% by weight |
| Ester gum | 10% by weight |
| Paraffin wax (mineral wax) | 1% by weight |

The above components were heated and kneaded by a pressurize kneader at a temperature of 130 to 150 degrees C., and thereby a sheet having 130 mm diameter and 3 mm thickness was molded. With this composition, the same tests as in Example 1 were carried out. The results are shown in Table 1.

### Comparative Example 2

The same tests as in Example 1 were carried out by the use of “Impact Guard” that is a mouth guard material manufactured by GC Corporation. The results are shown in Table 1.

TABLE 1

| | | Example | | | | Comp. Ex. | |
|---|---|---|---|---|---|---|---|
| | | 1 | 2 | 3 | 4 | 1 | 2 |
| Dynamic | 1 Hz | 36.5 | 30.5 | 40.1 | 37.5 | 10.1 | 9.5 |
| modulus of | 10 Hz | 46.0 | 41.3 | 51.4 | 47.2 | 12.4 | 10.2 |
| elasticity | | | | | | | |
| (MPa) | | | | | | | |

| | | | | | | |
|---|---|---|---|---|---|---|
| Degree of wearing | Almost | Almost no | Slightly | Almost no | Considerably | Considerably |
| | no | wearing | worn | wearing | worn | worn and a part |
| | wearing | | | | and a part | of the bitten |
| | | | | | of the | surface was |
| | | | | | bitten | damaged |
| | | | | | surface | |
| | | | | | was | |
| | | | | | damaged | |

As shown in Table 1, the mouth guard compositions of Examples have the dynamic modulus of elasticity which is approximately three times larger than those of Comparative Examples in which no polyolefin resin is contained therein. This indicates that the composition of the Examples is extremely difficult to be distorted. In addition, any dynamic modulus of elasticity at both 1 Hz and 10 Hz show high numerical values. This indicates that the distortion is maintained at low level even when the rate of the force applied to the composition is high, and it could be understood that the distortion can be maintained at low level under any condition. Furthermore, the compositions of the Examples exhibit almost no wearing as compared with the commercially available mouth guard composition after repeated use within the oral cavity, thus, the mouth guard which has a high resistance against wear can be provided.

What is claimed is:

1. A mouth guard composition comprising:
39 to 98% by weight of styrene block copolymer;
1 to 60% by weight of one or more kinds of thermoplastic resins selected from the group consisting of aliphatic cyclic saturated hydrocarbon resin, terpene resin, aliphatic petroleum resin, and ester gum;
0.1 to 40% by weight of one or more kinds of waxes selected from the group consisting of mineral wax, synthetic wax, plant wax, and animal wax; and
0.1 to 20% by weight of polyolefin resin.
